(19) United States
(12) Patent Application Publication
(10) Pub. No.: US 2002/0154164 A1
(43) Pub. Date: Oct. 24, 2002

(54) Generating messages with limited keyboards

(76) Inventor: Edward O. Clapper, Tempe, AZ (US)

Correspondence Address: Timothy N. Trop, TROP, PRUNER & HU, P.C., 8554 KATY FWY, STE 100, HOUSTON, TX, 77024-1805, US

(21) Appl. No.: 09/840,670

(22) Filed: Apr. 23, 2001

(51) Int. Cl. G06F 3/00; G06F 13/00

(52) U.S. Cl. 345/752; 345/810

(57) ABSTRACT

Graphical user interfaces may be utilized to enable mouse selection of message segments to assemble an overall message with a limited keyboard. In one embodiment, the user may select from among a plurality of user specified options for each of a plurality of message segments corresponding to message subjects, objects and verbs. The actual assembly of the message from the user's selections may be done locally or remotely.

### BACKGROUND

This invention relates generally to electronic devices with relatively limited keyboards that generate messages for transmission between devices.

A range of devices generate messages using relatively limited keyboards. One common reason for having relatively limited keyboards is to provide electronic devices of smaller size. Examples of electronic devices with limited keyboards include cellular telephones, pagers, electronic mail devices, remote control units, web tablets, digital cameras, and personal digital assistants, to mention a few examples. In each of these cases, relatively limited keyboards may be provided even in devices that have relatively advanced capabilities.

Many devices with limited keyboards may be utilized to communicate with other devices. However, because of the limited keyboards, typing messages may be relatively awkward and time consuming. In some cases, limited keyboards may be relatively small and thereby may be difficult to operate. The time it takes to enter a typed message may be much greater than would be experienced with full scale or unlimited keyboards.

The type of messaging that may be possible with limited keyboards may be somewhat limited as well. This adversely effects the usefulness of such devices, at least with respect to generating text-based messages.

Thus, there is a need for a better ways to generate messages from devices that utilize limited keyboards.

### BRIEF DESCRIPTION OF THE DRAWINGS

FIG. 1 is a block diagram of one embodiment of the present invention;

FIG. 2 is a block diagram of another embodiment of the present invention;

FIG. 3 is a schematic depiction of a technique for assembling a message in accordance with one embodiment of the present invention;

FIG. 4 is a flow chart for set up software in accordance with one embodiment of the present invention; and

FIG. 5 is a flow chart for software in accordance with one embodiment of the present invention.

### DETAILED DESCRIPTION

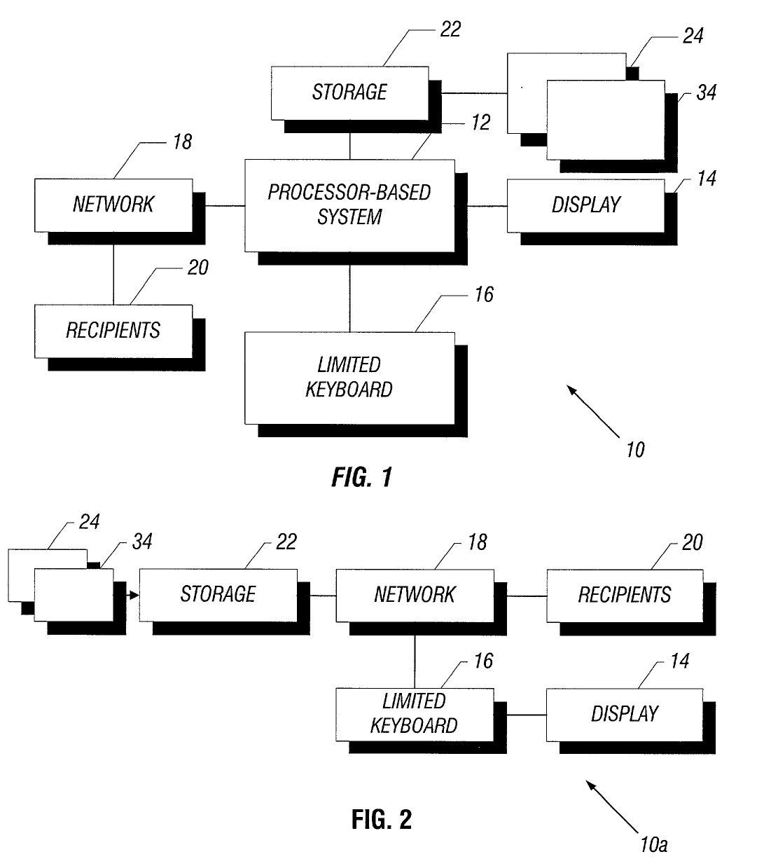

Referring to FIG. 1, in accordance with one embodiment of the present invention, a processor-based system 12 may communicate over a network 18 with a plurality of message recipients 20 also connected to the network 18. The processor-based system 12 may include a storage 22 that stores software 24 and 34 for controlling the operation of the processor-based system 12 and particularly for generating messages over the network 18. Thus, the system 12 may act as a standalone computer in one embodiment of the present invention. Nonetheless, the processor-based system may include a limited keyboard 16. Key selections and other information may be displayed on a display 14.

A number of networkable, processor-based systems may be used as the system 12 with a limited keyboard including cellular telephones, remote control units, web tablets, digital cameras, and laptop computers as well as personal digital assistants, as a few examples.

Because of the presence of a reduced or a limited keyboard 16, the generation of messages may be unduly time consuming. Generally, selecting each message may involve selecting individual characters using a relatively awkward system such as reduced sized keys, an on-screen keyboard, or a keyboard where the same key must be repeated operated to select one of a plurality of characters entered using the same key.

In accordance with another embodiment of the present invention, shown in FIG. 2, a relatively limited keyboard 16 may be coupled directly to a network 18. The network 18 may provide the storage 22 and software 24 and 34 to facilitate message generation. In other words, the network 18 provides services to the limited keyboard 16 to facilitate the generation of messages. Selections on the keyboard 16 may be transmitted over the network 18 for translation into understandable messages that are transmitted to recipients 20. The messages that are generated may be displayed on a display 14 associated with the keyboard 16 and ultimately transmitted over the network 18 to recipients 20.

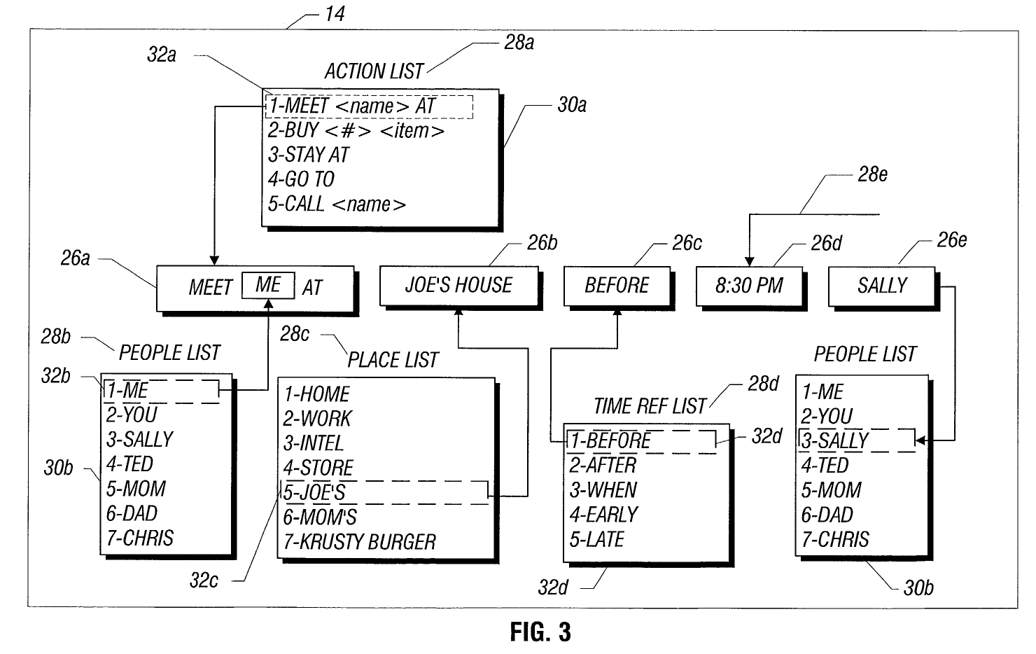

Referring to FIG. 3, the generation of a message may be facilitated by providing a plurality of graphical user interfaces 30 that may be pre-prepared by the user. In one embodiment, the interfaces 30 may be appropriately distributed on a display proximate to message display segments 26. Each interface 30 may be responsible for providing selectable message segments 26. Generally the message segments 26 may each be a subject, a verb, an object, or a time frame for messages, in one embodiment of the present invention.

The graphical user interfaces 30a provides a list 28a of selectable of verb or action entries. The verb entries may include the “meet” entry 32a as well as other commonly utilized or user-selected action items. In this case, the user has selected the meet entry 32a that now appears on a display portion 26a. The object of the meet entry 32a may be selected from a graphical user interface 32b, called the people list 28b, listing a plurality of people such as “me” as indicated at 32b. Thus, the user can select any of the entries on the graphical user interface 30b to provide the object in the display segment 26a for the meet action selected from graphical user interface 30a.

In one embodiment of the present invention, a mouse selection may be utilized to select entries from the interfaces 30. In such an embodiment the user simply clicks on the desired entry 32 in a graphical user interface 30. This reduces the need for manually typing in each character of the message. By having a plurality of pre-prepared message segments 26, that are user selectable, the user can readily generate a number common messages without having to enter individual characters using the limited keyboard 16.

Continuing in FIG. 3, additional message segments 26b and 26c may be selected from the interface 32c displaying a list 28c of place entries 32c and an interface 32d displaying a list 28d of time entries 32d. In addition, a numerical entry may be selected from the keyboard 16 display segment for the display segment 26d as indicated at 28e. Finally, the people list interface 30b may be reused to provide a signature in the display segment 26e.

Thus, a relatively elaborate message may be composed largely (or entirely) through mouse selections in one embodiment. Conventional mouse selections available in limited keyboard devices include a touchscreen, a mouse stick, a roller ball, a reduced size mouse, a stylus, or a rocker button, as examples.

The message generating system may be utilized in a variety of systems including those of the types shown in FIGS. 1 and 2. The processor-based system 10, shown in FIG. 1, may include enough processing power to locally execute the software 24 and 34 to implement the message generation system. The resulting message may then be sent over network 18 to potential recipients 20.

Conversely, in the system 10a, shown in FIG. 2, the network 18, or a server associated with the network 18, may provide the messaging service to systems including limited keyboards 16. Thus, instead of locally generating the message, the message may be generated remotely based on entries entered locally. That is, the interfaces 30 way be generated remotely for local selection.

The set up software 34 may be based locally, in a case of an embodiment like that shown in FIG. 1, or remotely in the case of the embodiment shown in FIG. 2. The set up software 34 may enable the various graphical user interfaces 30 to be set up by the user based on the user's anticipated messaging needs, in one embodiment.

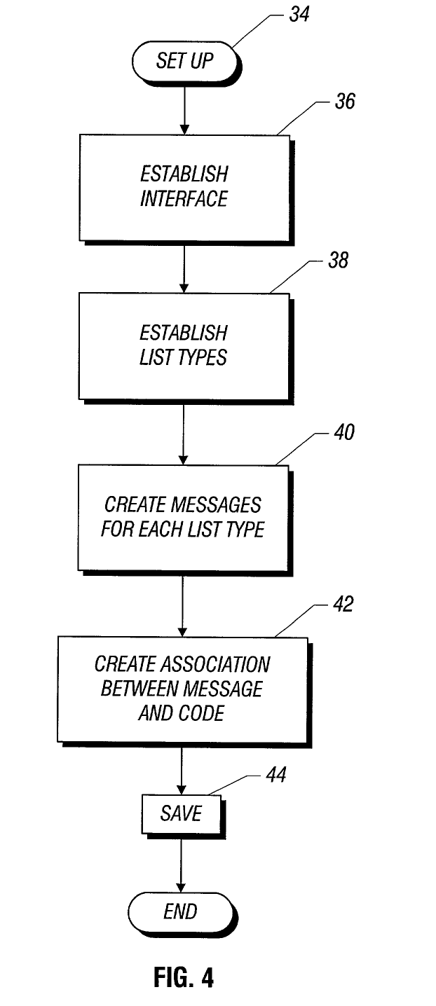

Initially, the software 34 provides a blank interface 30 as indicated in block 36 of FIG. 4. The blank interface 30 enables a plurality of lists 28 to be enumerated and linked to different positions in an overall message represented by the segments 26.

Initially each of the entries may be entered character-by-character. Alternatively, the entries 32 may be selected from a default list of entries provided by the setup software 34.

Each of the lists may be provided with type names such as a people list 28b, place list 28c and time reference list 28d, as examples, to denominate what types of entries will be offered by the interface 30, as indicated in block 38.

For each established list type, a graphical user interface 30 may be completed by providing entries 32 in association with each graphical interface 30 as indicated in block 40. An association may be created between each message segment 26 and an overall message. Namely, in one embodiment, each message interface 30 may be linked to a particular segment 26 of the overall displayed message as indicated in block 42. Then, each of the lists may be saved to automatically come up as a graphical user interface 30 linked to a particular segment 26. Upon selection of an entry 32 in the list depicted in an interface 30, an entry is automatically displayed in the linked message segment 26.

In one embodiment, only a single interface is displayed at a time. Each interface may successively appear for each segment 26 in sequence, until the message is complete (i.e., all segments 26 have been completed).

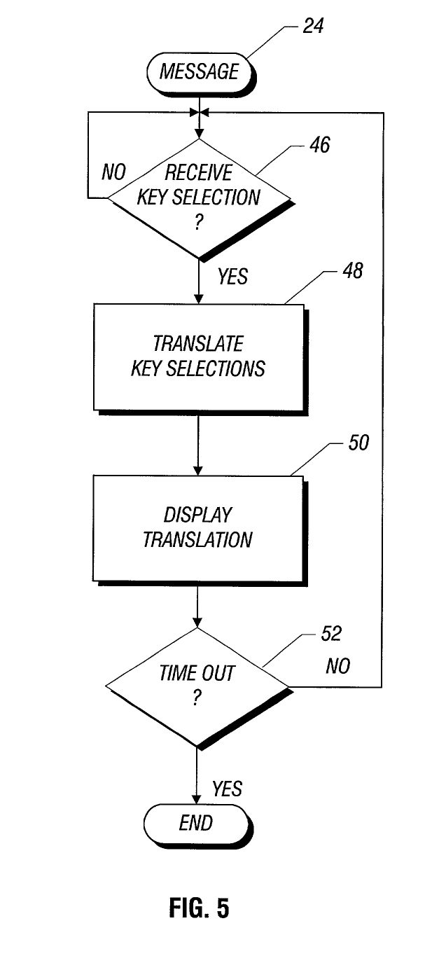

Referring to FIG. 5, the message software 24, in accordance with one embodiment of the present invention, actually assembles the message based on user selections. Initially, at diamond 46, the software 24 determines whether a key selection has been received. If so, the key selection is translated into the selection of an entry 32 and a particular list 28 is displayed on a graphical user interface 30, as indicated in block 48.

The graphical user interfaces 30 may automatically appear, in one embodiment to the present invention, in association with each of the segments 26. Alternatively, the interfaces 30 may be selected for viewing using an interface (not shown) displaying the available lists 28, in accordance with one embodiment of the present invention.

The resulting translated message is then displayed in the appropriate or linked segment 26 as indicated in block 50. If a time out has not occurred, due to inaction, as indicated in block 52, the message generation software 24 continues to cycle. Once a time out occurs, the flow ends.

In accordance with still another embodiment of the present invention, the sender of a message may actually receive a list of message formats audibly. For example, a service provider may audibly provide a plurality of message options. Those options may be the same for a variety of different users or may be custom-designed by or for a particular user. In one model, the user may pay a service fee to a service provider to maintain the message options.

The list of message options may be accessed by dialing a particular telephone number. A particular message format may be selected from an audible list of message options. For example, when the service provider's number is called, the user may be provided with an audible list of prepared message options. In one embodiment, each message may be audibly numbered and the user may audibly enter on a telephone key pad the number of the message that the user wishes to select.

Once the message has been selected, the user may be asked to fill in one or more blanks in the message to specify additional information. The blanks may be filled in in a variety of ways. In one embodiment, the user is provided with a list of audible options for pre-prepared words to fill in the blank. As another embodiment, the user can state the word or words to fill in the blank and the user spoken statement may be recognized and the corresponding statement inserted into the blank.

In one embodiment, each message may end with a signature. The signature may be provided by entering an access code through a telephone key pad. The use of the access code automatically appends the correct signature and ensures that unauthorized users may not access the system.

The service provider may then send the completed message, for example, to a recipient pager. Thus, the message is automatically converted into a text message and transmitted to a pager in one embodiment. As another embodiment, the message may be sent as an e-mail or fax.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a plurality of user selectable message options; and
enabling the user to compile a message by selecting from among the available message options.

2. The method of claim 1 wherein providing message options includes displaying a graphical user interface listing a plurality of message options.

3. The method of claim 2 including providing plurality of pre-selected display segments and providing a plurality of user selectable options for each segment.

4. The method of claim 3 including displaying a list of user-selectable options for a plurality of display segments.

5. The method of claim 4 including enabling the options to be displayed as a list of options.

6. The method of claim 5 including enabling the user to mouse select an option from each of the plurality lists to complete a message.

7. The method of claim 6 including displaying a graphical user interface in association with each of a plurality of display segments.

8. The method of claim 7 including linking a list of options to a display segment so that when an option is selected it appears on a display associated with a particular display segment.

9. The method of claim 1 including generating an interface displaying said options and conveying said interface to a local system over a network.

10. The method of claim 1 including generating a graphical user interface to locally display said options, developing said message locally, and transmitting said message remotely over a network.

11. The method of claim 1 including audibly providing a plurality of user selectable message options.

12. The method of claim 11 including enabling the user to compile a message by selecting from among available audible message options by making key selections on a telephone.

13. An article comprising a medium storing instructions that enable a processor-based system to:
provide a plurality of user selectable message options; and
enable the user to compile a message by selecting from among the available message options.

14. The article of claim 13 further storing instructions that enable the processor-based system to display a graphical user interface listing a plurality of message options.

15. The article of claim 14 further storing instructions that enable the processor-based system to provide a plurality of pre-selected display segments and provide a plurality of user selectable options for each segment.

16. The article of claim 15 further storing instructions that enable the processor-based system to display a list of user selectable options for a plurality of display segments.

17. The article of claim 16 furthering storing instructions that enable the processor-based system to display the options as a list of options.

18. The article of claim 17 further storing instructions that enable the processor-based system to allow the user to mouse select an option from each of plurality of lists to complete a message.

19. The article of claim 18 further storing instructions that enable the processor-based system to display a graphical user interface in association with each of a plurality of display segments.

20. The article of claim 19 further storing instructions that enable the processor-based system to link a list of options to a display segment so that when an option is selected it appears on a display associated with a particular display segment.

21. The article of claim 13 further storing instructions that enable the processor-based system to generate an interface displaying said options and convey said interface to a local system over a network.

22. The article of claim 13 further storing instructions that enable the processor-based system to generate a graphical user interface to locally display said options, locally develop said message, and transmit said message remotely over a network.

23. The article of claim 13 further storing instructions that enable the processor-based system to audibly provide a plurality of user-selectable message options.

24. The processor-based system comprising:
a processor; and
a storage storing instructions that enable said processor to provide a plurality of user selectable message options and enable the user to compile a message by selecting from among the available message options.

25. The system of claim 24 wherein said storage stores instructions that enable the processor to display a graphical user interface listing a plurality of message options.

26. The system of claim 24 wherein said storage stores instructions that enable the processor to provide a plurality of pre-selected display segments and provide a plurality of user selected options for each segment.

27. The system of claim 24 wherein said system is a server.

28. The system of claim 24 wherein said system is a client.

29. The system of claim 24 wherein said storage stores instructions that enable said processor to audibly provide a plurality of user selectable message options.

30. The system of claim 24 coupled to a telephone network to provide said user selectable message options over the telephone.
